(19) United States
(12) Patent Application Publication
(10) Pub. No.: US 2018/0151102 A1
(43) Pub. Date: May 31, 2018

(54) DISPLAY CONTROL DEVICE, DISPLAY SYSTEM, AND DISPLAY CONTROL METHOD

(71) Applicant: Panasonic Intellectual Property Management Co., Ltd., Osaka (JP)

(72) Inventors: WATARU NAKAI, Tokyo (JP); TAKASHI OKOHIRA, Kanagawa (JP)

(21) Appl. No.: 15/570,476

(22) PCT Filed: May 10, 2016
(86) PCT No.: PCT/JP2016/002280

§ 371 Date: Oct. 30, 2017

(30) Foreign Application Priority Data
May 21, 2015 (JP) 2015-103574

(51) Int. Cl. G09G 3/20; H04N 7/18; B60R 1/00

(52) U.S. Cl. CPC G09G 3/2003; H04N 7/183; B60R 2300/802; G09G 2360/144; B60R 2300/30; B60R 1/002

(57) ABSTRACT

A display control device includes: a detector that detects an operating state of a light emitting device that is provided to a vehicle and blinks; and an output controller that, when the detector detects an operation of the light emitting device, outputs a peripheral image captured by an imaging device that images a periphery of the vehicle at timing at which the light emitting device is off, and outputs notification information representing that the light emitting device is operating.

### TECHNICAL FIELD

The present disclosure relates to a display control device, a display system, and a display control method that output a peripheral image of a vehicle to a display unit.

### BACKGROUND ART

Conventionally, there has been a vehicle periphery monitor device that can monitor a blind area of the vehicle. The vehicle periphery monitor device is configured by mounting a camera to a vehicle.

Generally, a vehicle is provided with a plurality of lamps such as brake lamp, a tail lamp, a winker lamp, and a back lamp. However, light emitted from these lamps causes smear in an image captured by a camera in some cases.

FIG. 10 is a diagram illustrating one example of timing of blinking of a light emitting diode (LED) lamp that blinks at a high speed, timing of opening/closing of an electronic shutter of a camera, and timing of charge coupled device (CCD) imaging element, which is provided to the camera, to output an electric charge to a memory in a conventional vehicle periphery monitor device.

In this case, the electronic shutter is in an open state when the LEDs emit light. Therefore, smear is caused by the light from the LEDs, and it is difficult to monitor a blind area in some cases.

In order to solve such a problem, PTL 1, for example, discloses a vehicle periphery monitor device that catches near-infrared light, captures an image at timing that is defined by inverting an illumination pulse of a lamp provided to the vehicle, and displays an image captured while the lamp is off.

### CITATION LIST

### Patent Literature

PTL 1: Unexamined Japanese Patent Publication No. 2005-178576

### SUMMARY OF THE INVENTION

However, since the configuration in PTL 1 displays the image captured while the lamp is off, there was a problem such that a driver cannot check whether the lamp is in a state of emitting light because the light of the lamp does not appear in the image.

It is an object of the present disclosure to provide a display control device, a display system, and a display control method that improves visibility of an image and that enables checking of a light emitting state of a light emitting device.

In order to achieve the above object, a display control device of the present disclosure includes a detector that detects an operating state of a light emitting device that is provided to a vehicle and blinks, and an output controller that, when the detector detects an operation of the light emitting device, outputs a peripheral image captured by an imaging device that images a periphery of the vehicle at timing at which the light emitting device is off and outputs notification information representing that the light emitting device is operating.

Further, a display system of the present disclosure includes an image acquisition unit that is disposed in the vehicle and acquires a peripheral image captured by an imaging device that images a periphery of the vehicle, a light emission controller that controls blinking of the light emitting device provided to the vehicle, and the display control device.

Further, a display control method of the present disclosure includes detecting an operating state of a light emitting device that is provided to a vehicle and blinks, and when an operation of the light emitting device is detected in the detecting, outputting a peripheral image captured by an imaging device that images a periphery of the vehicle at timing at which the light emitting device is off, and notification information representing that the light emitting device is operating.

According to the present disclosure, visibility of an image is improved and a light emitting state of the light emitting device can be checked.

### BRIEF DESCRIPTION OF DRAWINGS

FIG. 1 is a block diagram illustrating one example of a configuration of a display system according to a first exemplary embodiment.

FIG. 2 is a diagram illustrating timing of image output in a display control process according to the first exemplary embodiment.

FIG. 3 is a diagram illustrating examples of peripheral images of a vehicle captured when a light emitting device is on and off.

FIG. 4 is a diagram illustrating one example of notification information representing that the light emitting device is operating.

FIG. 5 is a flowchart illustrating one example of a procedure of the display control process according to a first exemplary embodiment.

FIG. 6 is a diagram illustrating timing of image output in a display control process according to a second exemplary embodiment.

FIG. 7 is a flowchart illustrating one example of a procedure of the display control process according to the second exemplary embodiment.

FIG. 8 is a flowchart illustrating one example of a procedure of a display control process according to a third exemplary embodiment.

FIG. 9 is a flowchart illustrating one example of a procedure of a display control process according to a fourth exemplary embodiment.

FIG. 10 is a diagram illustrating one example of timing of an operation in a conventional vehicle periphery monitor device.

### DESCRIPTION OF EMBODIMENTS

Hereinafter, the exemplary embodiments of the present disclosure will be described with reference to the drawings.

### First Exemplary Embodiment

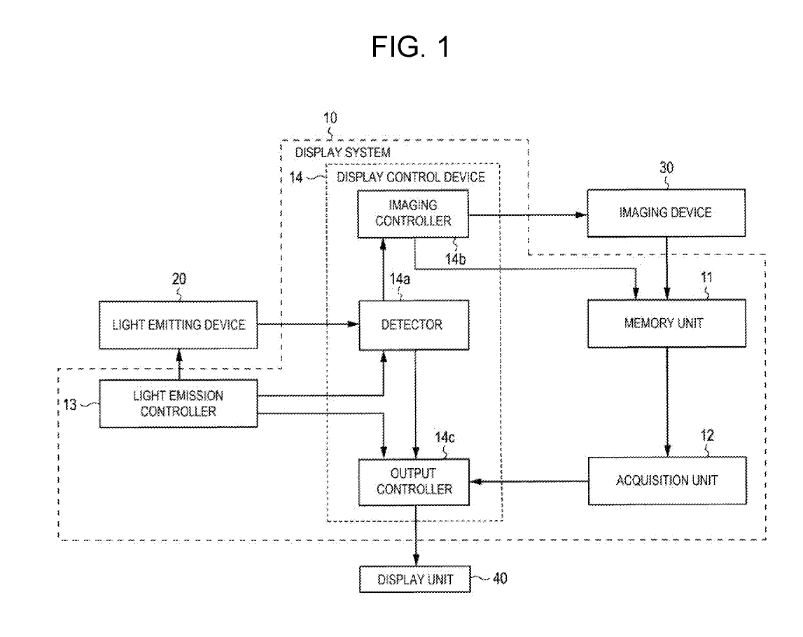

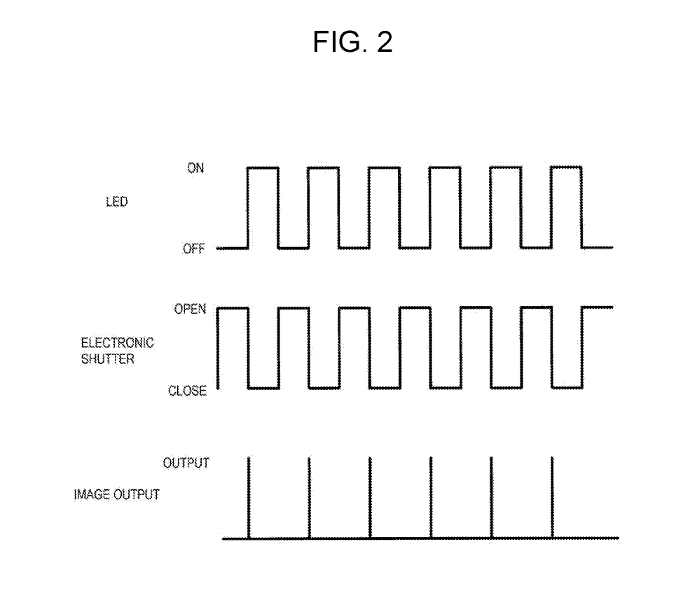

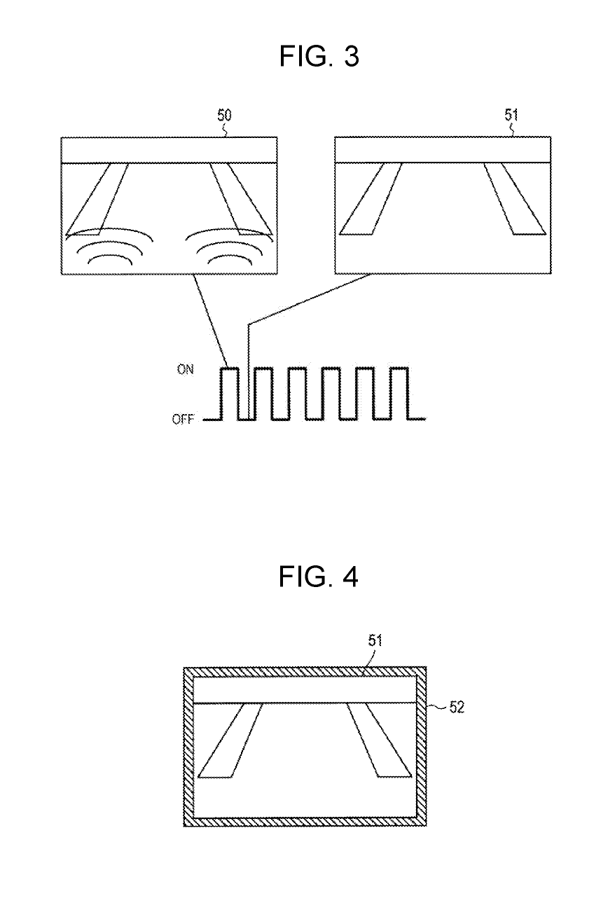

FIG. 1 is a block diagram illustrating one example of a configuration of display system 10 according to a first exemplary embodiment. FIG. 2 is a diagram illustrating timing of image output in a display control process according to the first exemplary embodiment. Further, FIG. 3 is a diagram illustrating examples of peripheral images of a vehicle captured when light emitting device 20 is on and off. FIG. 4 is a diagram illustrating one example of notification information representing that light emitting device 20 is operating.

As illustrated in FIG. 1, display system 10 is connected to light emitting device 20, imaging device 30, and display unit 40.

Light emitting device 20 is installed in a vehicle, and adopts, as a light source, light emitting diodes (LEDs) that blink and emit light at a high speed with a predetermined frequency. For example, light emitting device 20 includes brake lamps, tail lamps, back lamps and winker lamps whose light sources each are LEDs.

Specifically, light emitting device 20 has a driver circuit and LEDs. The driver circuit generates a drive signal upon reception of a light emitting command from light emission controller 13, and outputs the drive signal to the LEDs. The LEDs are on and off repeatedly in a periodic manner upon reception of the drive signal (see the LEDs being on and off, as illustrated in FIG. 2). The light source is not limited to the LEDs, and another lamp may be used.

Imaging device 30 includes a charge coupled device (CCD) imaging element and an electronic shutter that controls a light receiving time of the CCD imaging element, and captures a peripheral image of the vehicle using them. In this configuration, imaging device 30 has the electronic shutter, but may have a mechanical shutter.

For example, imaging device 30 causes the electronic shutter to be in an open state to form an image of light from an imaging region (a peripheral portion of the vehicle) through an optical system on a plane. The CCD imaging element arranged on the plane then converts brightness of light into an amount of an electric charge. An open/close operation of the electronic shutter is controlled by a control signal output from imaging controller 14b.

Display unit 40 is a unit such as a liquid crystal display or a headup display, which displays an image. Display unit 40 displays an image output by output controller 14c.

Display system 10 is a system that outputs an image captured by imaging device 30 to display unit 40. Display system 10 includes memory unit 11, image acquisition unit 12, light emission controller 13, and display control device 14.

Memory unit 11 stores image data of the image captured by imaging device 30. Image acquisition unit 12 reads the image data stored in memory unit 11 from memory unit 11 at predetermined timing, and outputs the image data to output controller 14c.

Light emission controller 13 outputs a light-emitting command and a non-light-emitting command to light emitting device 20 and detector 14a. For example, when light emitting device 20 is a brake lamp, light emission controller 13 outputs the light-emitting command when it detects that a driver is pressing a brake pedal. Light emission controller 13 outputs the non-light-emitting command when it detects that the driver is not pressing the brake pedal. When light emitting device 20 is a tail lamp, light emission controller 13 outputs the light-emitting command when it detects that the driver turned on the tail lamp. Light emission controller 13 outputs the non-light-emitting command when it detects that the driver turned off the tail lamp.

When light emitting device 20 is a back lamp, light emission controller 13 outputs the light-emitting command when it detects that the driver put the vehicle into reverse gear. Light emission controller 13 outputs the non-light-emitting command when it detects that the driver put the vehicle, from the reverse gear state, into a state other than the reverse gear state. When light emitting device 20 is a winker lamp, light emission controller 13 outputs the light-emitting command and non-light-emitting command alternately at predetermined intervals when it detects that the driver turned on the winker lamp. Light emission controller 13 outputs non-light-emitting command when it detects that the driver turned off the winker lamp.

Further, light emission controller 13 outputs emission color information of light emitting device 20 to output controller 14c.

Display control device 14 controls display of an image on display unit 40. Display control device 14 includes detector 14a, imaging controller 14b, and output controller 14c.

Detector 14a detects an operating state of light emitting device 20, and outputs a signal representing the detected result to imaging controller 14b and output controller 14c. Further, detector 14a detects a blinking state of light emitting device 20, and outputs a signal representing the detected result to imaging controller 14b.

For example, detector 14a acquires the light-emitting command and non-light-emitting command from light emission controller 13, and detects the operating state of light emitting device 20. Detector 14a outputs a signal representing that light emitting device 20 is operating to imaging controller 14b and output controller 14c when it acquires the light-emitting command from light emission controller 13. Further, detector 14a detects the blinking state of light emitting device 20 by a method for detecting an electric current flowing in the LEDs when the LEDs repeatedly being on and off, or by detecting that LEDs are actually turned on and off thorough a photosensor and the like.

Imaging controller 14b controls the imaging process in imaging device 30, and input/output timing of image data in memory unit 11.

Specifically, while light emitting device 20 is operating, imaging controller 14b generates a control signal for controlling imaging device 30 to capture an image of a periphery of the vehicle at timing at which the LEDs are off (see FIG. 2). Imaging controller 14b then outputs the control signal to imaging device 30.

As a result, the electronic shutter is controlled such that when the LEDs are in an off state, the electronic shutter is opened, and when the LEDs in an on state, the electronic shutter is closed.

As a result, the CCD imaging element receives light from an imaging region while light emitting device 20 is off, and does not receive light from the imaging region when light emitting device 20 is on (see timing of blinking of the LEDs and timing of open/close of the electronic shutter illustrated in FIG. 2).

Further, imaging controller 14b transfers the electric charge accumulated in the CCD imaging element to memory unit 11 (see image output illustrated in FIG. 2) every time when the electronic shutter becomes closed state.

Output controller 14c acquires the peripheral image captured by imaging device 30 from image acquisition unit 12 and outputs the peripheral image to display unit 40.

Specifically, output controller 14c acquires the peripheral image captured by imaging device 30 (peripheral image 51 in FIG. 3) from image acquisition unit 12 at timing at which it is off, and outputs the acquired image to display unit 40. As illustrated in FIG. 3, light from light emitting device 20 does not appear in peripheral image 51 that has been captured by imaging device 30 at timing at which it is off unlike peripheral image 50 captured by imaging device 30 at timing at which it is on. Thus, a driver cannot check whether the lamp is emitting light.

For this reason, when detector 14a detects the operation of light emitting device 20, output controller 14c outputs notification information representing that light emitting device 20 is operating.

Specifically, when detector 14a detects the operation of light emitting device 20, output controller 14c generates trimming image 52 obtained by trimming a periphery of peripheral image 51 with a color equal to or similar to the emission color of light emitting device 20, based on the emission color information acquired from light emission controller 13.

Output controller 14c outputs peripheral image 51 captured at timing at which it is off to display unit 40, and outputs trimming image 52 to display unit 40, thereby displaying these images on display unit 40.

In such a manner, peripheral image 51 captured at the timing at which it is off is displayed on display unit 40. Accordingly, an influence of light from light emitting device 20 can be eliminated, and visibility of a peripheral image can be improved. Further, display of trimming image 52 on display unit 40 can notify the driver of the operation of light emitting device 20.

On the other hand, when light emitting device 20 is not operating, output controller 14c does not output trimming image 52 to display unit 40, and outputs only peripheral image 51 captured at predetermined timing to display unit 40.

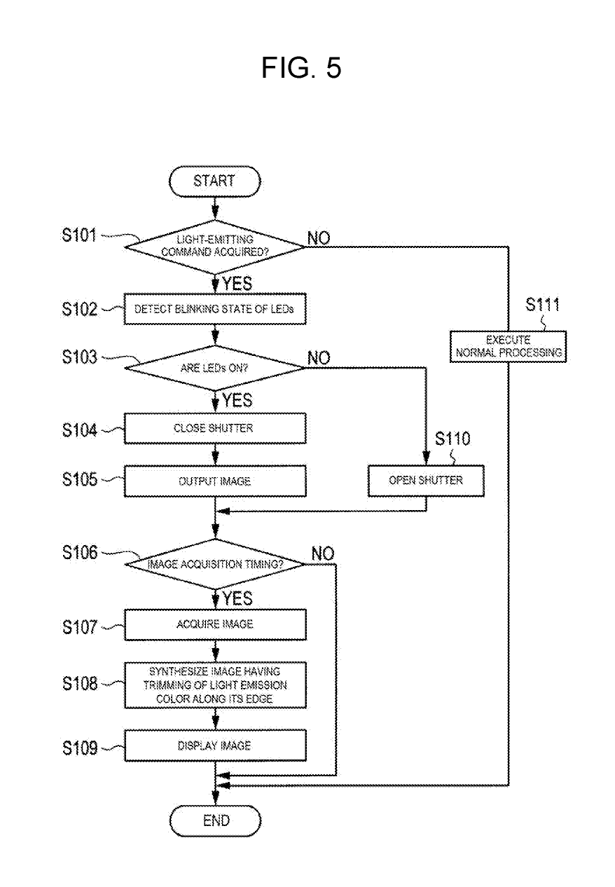

A procedure of the display control process in the first exemplary embodiment will be described below with reference to FIG. 5. FIG. 5 is a flowchart illustrating one example of the procedure of the display control process in the first exemplary embodiment.

Detector 14a first determines whether light emitting device 20 is operating, based on the light-emitting command and the non-light-emitting command acquired from light emission controller 13 (step S101). When detector 14a determines that light emitting device 20 is not operating (No in step S101), a normal process is executed (S111). In the normal process, imaging controller 14b controls imaging device 30 to capture an image of a periphery of the vehicle by opening and closing the electronic shutter at predetermined timing. Further, in the normal process, only peripheral image 51 captured at the predetermined timing is displayed on display unit 40 without displaying trimming image 52 on display unit 40. The display control process is then terminated. Thereafter, the display control process is again started.

When detector 14a determines that light emitting device 20 is operating (YES in step S101), detector 14a detects a blinking state of the LEDs in light emitting device 20 (step S102).

Thereafter, imaging controller 14b receives the detected result from detector 14a, and determines whether the received detected result indicates they are on (step S103).

When the detected result indicates they are on (YES in step S103), imaging controller 14b controls imaging device 30 to close the electronic shutter (step S104).

Further, imaging controller 14b controls imaging device 30 so that the electric charge accumulated in the CCD imaging element is transferred to memory unit 11 and thereby peripheral image 51 captured by imaging device 30 is outputted to memory unit 11 (step S105).

On the other hand, when the detected result indicates they are off (NO in step S103), imaging controller 14b controls imaging device 30 to open the electronic shutter (step S110).

In such a manner, a peripheral portion of the vehicle when the LEDs are off is imaged. As described above, in the first exemplary embodiment, every time when the shutter is closed, peripheral image 51 is output to memory unit 11.

Image acquisition unit 12 then determines whether a current time is predetermined image acquisition timing (step S106). When the current time is not the predetermined image acquisition timing (NO in step S106), step S107 to step S109 are not performed, and the display control process is terminated. Thereafter, the display control process is again started.

When the current time is the predetermined image acquisition timing (YES in step S106), image acquisition unit 12 acquires peripheral image 51 from memory unit 11 (step S107), and outputs acquired peripheral image 51 to output controller 14c.

Output controller 14c then synthesizes trimming image 52 having the emission color of light emitting device 20 with an edge of peripheral image 51 (step S108). Output controller 14c causes display unit 40 to display peripheral image 51 and trimming image 52 that are synthesized with each other to display (step S109), and terminates the display control process. Thereafter, the display control process is again started.

In the display control process illustrated in FIG. 5, processing of step S101 to step S105, step S110, and processing of step S106 to step S109 are performed sequentially, but these processing may be performed in parallel.

Further, in the first exemplary embodiment, as the notification information representing that light emitting device 20 is operating, trimming image 52 is displayed on display unit 40, but a format of the notification information is not limited to this. For example, the notification information may be a mark indicating an operation target such as a brake.

Further, the notification information may be provided as a sound. For example, when light emitting device 20 is operating, output controller 14c may cause the speaker to output a voice message “the brake lamp is ON”. When light emitting device 20 is not operating, output controller 14c may cause the speaker to output a voice message “the brake lamp is OFF”.

As described above, in the first exemplary embodiment, detector 14a detects the operating state of light emitting device 20 that is provided to the vehicle and blinks. Output controller 14c then outputs the peripheral image captured by imaging device 30 that captures an image of a peripheral of the vehicle when light emitting device 20 is off. Furthermore, when detecting the operation of light emitting device 20, detector 14a outputs the notification information representing that light emitting device 20 is operating. Thus, visibility of an image can be improved, and the light emitting state of the light emitting device can be checked.

### Second Exemplary Embodiment

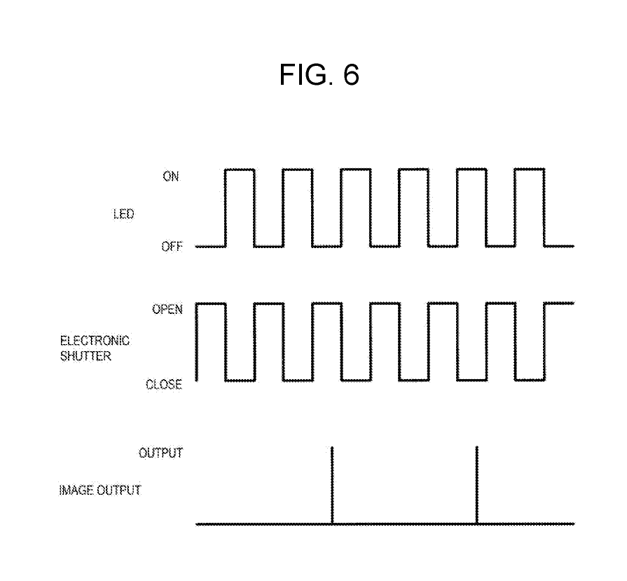

FIG. 6 is a diagram illustrating timing of image output in a display control process according to a second exemplary embodiment. A configuration of a display system according to the second exemplary embodiment is similar to the configuration of display system 10 illustrated in FIG. 1. Therefore, the description is made based on the configuration in FIG. 1.

In the first exemplary embodiment, imaging controller 14b has transferred the electric charge accumulated in the CCD imaging element to memory unit 11 every time when the electronic shutter is closed (see the image output illustrated in FIG. 2).

In contrast, in the second exemplary embodiment, imaging controller 14b transfers the electric charge to memory unit 11 every time when the electronic shutter is closed a plural number of times (see the image output illustrated in FIG. 6). In an example of FIG. 6, imaging controller 14b transfers the electric charge to memory unit 11 once every about two and half times of closing of the electronic shutter.

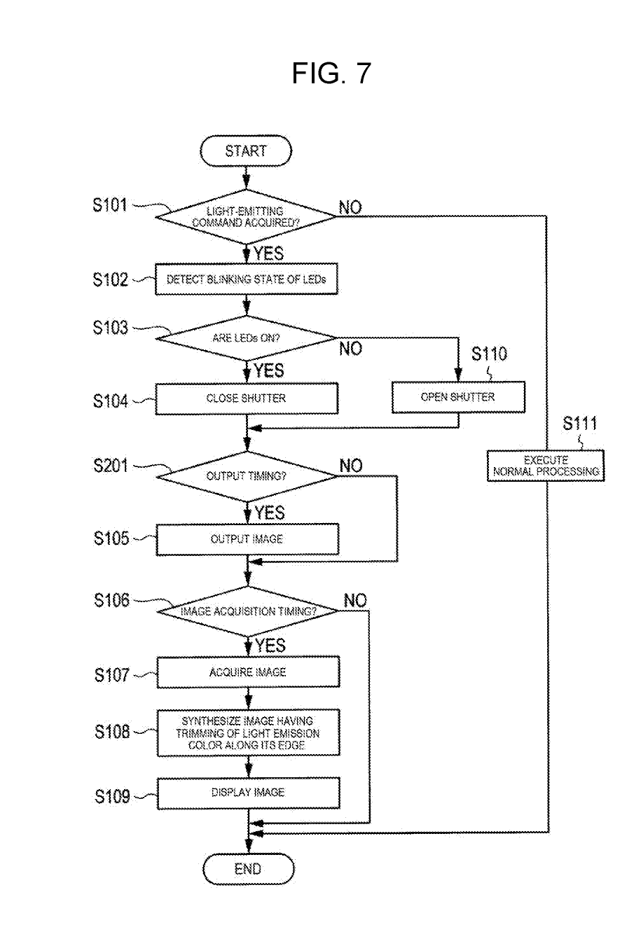

FIG. 7 is a flowchart illustrating one example of a procedure of the display control process in the second exemplary embodiment. The process in step S101 to step S104, step S110, step S111, step S106 to step S109 are same between the display control process illustrated in FIG. 5 and the display control process illustrated in FIG. 7.

However, in the display control process illustrated in FIG. 7, after step S104 or step S110, imaging controller 14b determines whether it is the timing of transferring the electric charge accumulated the CCD imaging element to memory unit 11 and thereby outputting peripheral image 51 to memory unit 11 (step S201). This timing is the timing at which the electronic shutter is closed the plural number of times as described above.

When the current time is not the timing of outputting peripheral image 51 to memory unit 11 (NO in step S201), step S106 is performed. When the current time is the timing of outputting peripheral image 51 to memory unit 11 (YES in step S201), imaging controller 14b transfers the electric charge accumulated in the CCD imaging element to memory unit 11. As a result, imaging controller 14b outputs peripheral image 51 captured by imaging device 30 to memory unit 11 (step S105). Thereafter, step S106 is performed.

In the display control process illustrated in FIG. 7, processing of step S101 to step S104, step S110, processing of step S201, step S105, and processing of step S106 to step S109 are performed sequentially, but these processing may be performed in parallel.

As described above, in the second exemplary embodiment, imaging controller 14b transfers the electric charge to memory unit 11 every time when the electronic shutter is closed the plural number of times. Thus, an amount of the electric charge accumulated in the CCD imaging element increases, and thus image quality can be further improved.

### Third Exemplary Embodiment

In the first exemplary embodiment, the operating state of light emitting device 20 has been detected by detecting the light-emitting command and the non-light-emitting command from light emission controller 13. A third exemplary embodiment describes a case in which the operating state of light emitting device 20 is detected by detecting that light emitting device 20 blinks at least once or more within a predetermined time.

Since a configuration of a display system in the third exemplary embodiment is similar to the configuration of display system 10 illustrated in FIG. 1, description is made based on the configuration in FIG. 1.

In this exemplary embodiment, detector 14a maintains the detected blinking state of light emitting device 20 for the predetermined time, and determines whether light emitting device 20 is on at least once or more in the maintained blinking state within the predetermined time. Detector 14a then outputs the determined result to imaging controller 14b and output controller 14c. When detector 14a detects that light emitting device 20 is on at least once or more within the predetermined time, it outputs a signal representing that light emitting device 20 is operating.

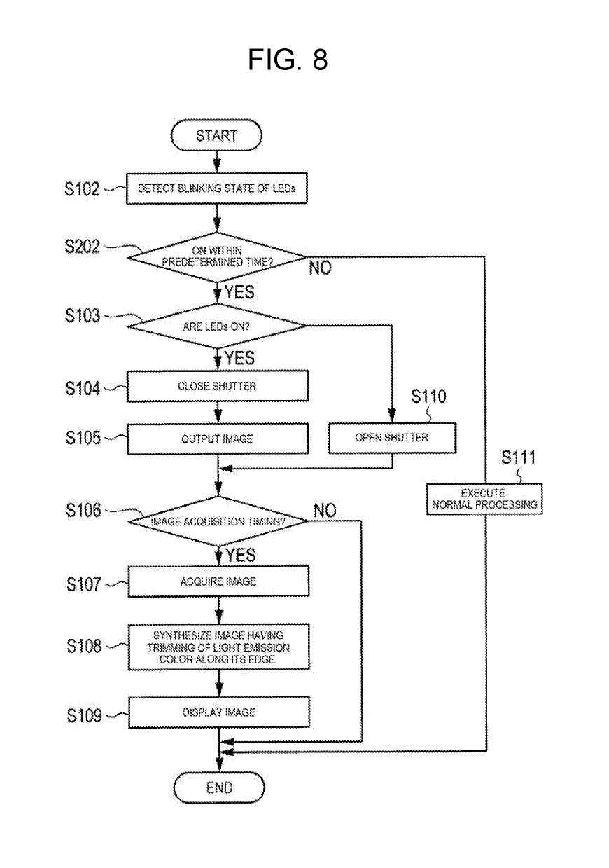

FIG. 8 is a flowchart illustrating one example of a procedure of the display control process according to the third exemplary embodiment.

Process in step S102 to step S106, step S110, step S111, and step S107 to step S109 are same between the display control process illustrated in FIG. 5 and the display control process illustrated in FIG. 8.

In the display control process illustrated in FIG. 8, after step S102, detector 14a determines whether the LEDs of light emitting device 20 are on once or more within the predetermined time (step S202).

When detector 14a determines that the LEDs are not on once or more within the predetermined time (NO in step S202), a normal process is executed such that only peripheral image 51 captured at predetermined timing is displayed on display unit 40 (step S111) without displaying trimming image 52 on display unit 40. The display control process is then terminated. Thereafter, the display control process is again started.

When detector 14a determines that the LEDs are on once or more within the predetermined time (YES in step S202), imaging controller 14b receives the detected result from detector 14a, and determines whether the received detected result indicates they are on (step S103).

In the display control process illustrated in FIG. 8, processing of step S102 to step S105, step S110, step S202, and processing of step S106 to step S109 are performed sequentially, but these processing may be performed in parallel.

As described above, in the third exemplary embodiment, actual blinking of the LEDs is detected. This prevents a situation where trimming image 52 is displayed even though the LEDs do not blink due to any cause such as a failure of the device. In the present exemplary embodiment, the operating state of light emitting device 20 is detected by detecting only an actual blinking state of light emitting device 20. However, the operating state may be detected by detecting also the light-emitting command and the non-light-emitting command. In this case, when detector 14a acquires the light-emitting command from light emission controller 13, and also detects that light emitting device 20 turns on at least once or more within the predetermined time, detector 14a outputs a signal representing that light emitting device 20 is operating.

### Fourth Exemplary Embodiment

In the second exemplary embodiment, similarly to the first exemplary embodiment, the operating state of light emitting device 20 has been detected by detecting the light-emitting command and the non-light-emitting command from light emission controller 13. A fourth exemplary embodiment will describe a case in which the operating state of light emitting device 20 is detected by detecting that light emitting device 20 blinks at least once or more within the predetermined time.

Since a configuration of a display system in the fourth exemplary embodiment is similar to the configuration of display system 10 illustrated in FIG. 1, description is made based on the configuration in FIG. 1.

In this exemplary embodiment, detector 14a maintains the detected blinking state of light emitting device 20 for the predetermined time, and determines whether light emitting device 20 is on at least once or more in the maintained blinking state within the predetermined time. Detector 14a then outputs the determined result to imaging controller 14b and output controller 14c. When detector 14a detects that light emitting device 20 is on at least once or more within the predetermined time, it outputs a signal representing that light emitting device 20 is operating.

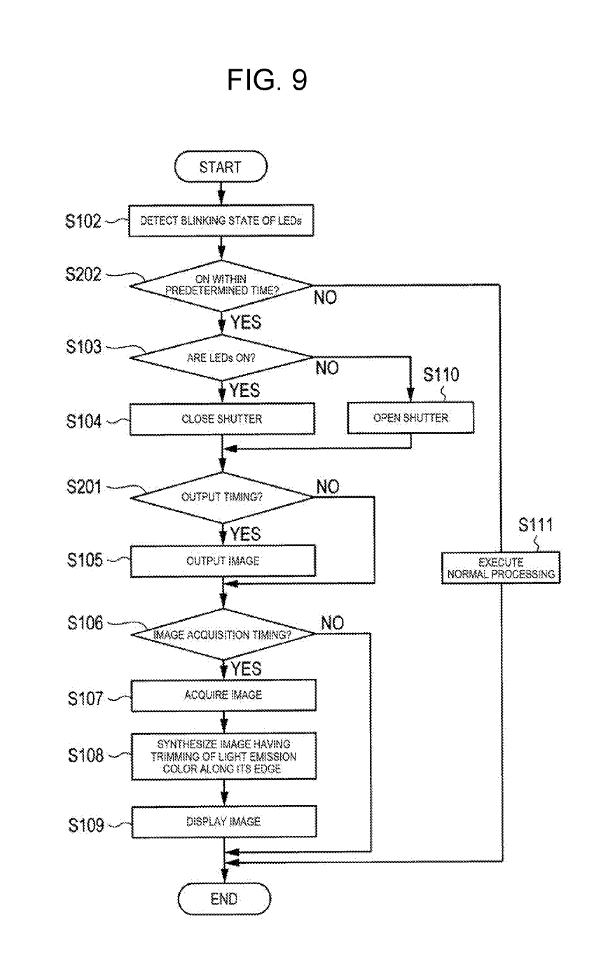

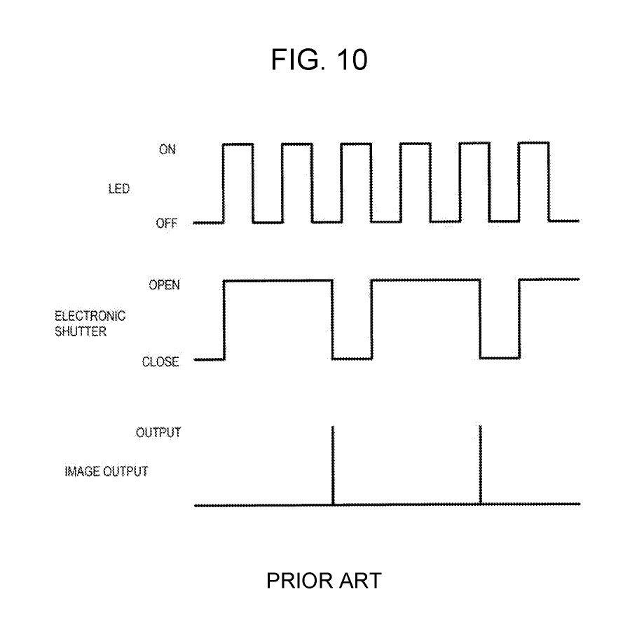

FIG. 9 is a flowchart illustrating one example of a procedure of the display control process according to the fourth exemplary embodiment.

Process in step S102 to step S106, step S110, step S111, step S107 to step S109 are same between the display control process illustrated in FIG. 7 and the display control process illustrated in FIG. 9.

In the display control process illustrated in FIG. 9, after step S102, detector 14a determines whether the LEDs of light emitting device 20 are on once or more within the predetermined time (step S202).

When detector 14a determines that the LEDs are not on once or more within the predetermined time (NO in step S202), a normal process is executed such that only peripheral image 51 captured at predetermined timing is displayed on display unit 40 (step S111) without displaying trimming image 52 on display unit 40. The display control process is then terminated. Thereafter, the display control process is again started.

When detector 14a determines that the LEDs are on once or more within the predetermined time (YES in step S202), imaging controller 14b receives the detected result from detector 14a, and determines whether the received detected result indicates that they are on (step S103).

In the display control process illustrated in FIG. 9, processing of step S102 to step S104, step S110, step S202, processing of step 201, step S105, and processing of step S106 to step S109 are performed sequentially, but these processing may be performed in parallel.

As described above, in the fourth exemplary embodiment, actual blinking of the LEDs is detected. This can prevent a situation where trimming image 52 is displayed even though the LEDs do not blink due to any cause such as a failure of the device. In the present exemplary embodiment, the operating state of light emitting device 20 is detected by detecting only an actual blinking state of light emitting device 20. However, the operating state may be detected by detecting also the light-emitting command and the non-light-emitting command. In this case, when detector 14a acquires the light-emitting command from light emission controller 13, and also detects that light emitting device 20 is on at least once or more within the predetermined time, detector 14a outputs a signal representing that light emitting device 20 is operating.

### INDUSTRIAL APPLICABILITY

The present invention can be applicable to a display control device, a display system, and a display control method that are needed to improve visibility of an image and to be able to check a light emitting state of a light emitting device.

### REFERENCE MARKS IN THE DRAWINGS

10: display system
11: memory unit
12: image acquisition unit
13: light emission controller
14: display control device
14a: detector
14b: imaging controller
14c: output controller
20: light emitting device
30: imaging device
40: display unit

1. A display control device comprising:
a detector that detects an operating state of a light emitting device that is provided to a vehicle and blinks; and
an output controller that, when the detector detects an operation of the light emitting device, outputs a peripheral image captured by an imaging device that images a periphery of the vehicle when the light emitting device is off, and outputs notification information representing that the light emitting device is operating.

2. The display control device according to claim 1, wherein the output controller outputs, as the notification information, a trimming image obtained by trimming a periphery of the peripheral image with an emission color of the light emitting device.

3. The display control device according to claim 1, further comprising
an imaging controller that outputs the peripheral image captured by the imaging device every time when a shutter of the imaging device is closed.

4. The display control device according to claim 1, further comprising
an imaging controller that outputs the peripheral image captured by the imaging device every time when a shutter of the imaging device is closed a plural number of times.

5. The display control device according to claim 1, wherein the detector detects an operation of the light emitting device by detecting a light-emitting command for causing the light emitting device to emit light.

6. The display control device according to claim 1, wherein the detector detects an operation of the light emitting device by detecting that the light emitting device turns on once or more within a predetermined time.

7. A display system comprising:
the display control device according to claim 1;
an image acquisition unit that is disposed in the vehicle and acquires the peripheral image captured by the imaging device that images the periphery of the vehicle; and
a light emission controller that controls blinking of the light emitting device provided to the vehicle.

8. A display control method comprising:
detecting an operating state of a light emitting device that is provided to a vehicle and blinks; and
when an operation of the light emitting device is detected in the detecting, outputting a peripheral image captured by an imaging device that images a periphery of the vehicle at timing at which the light emitting device is off, and notification information representing that the light emitting device is operating.
